(19) United States
(12) Patent Application Publication
(10) Pub. No.: US 2008/0320416 A1
(43) Pub. Date: Dec. 25, 2008

(54) SYSTEM, METHOD AND COMPUTER PROGRAM PRODUCTS FOR POINT OF CONTACT FAMILY SERVICES

(76) Inventor: M. Juanita Heinzen, St. Petersburg, FL (US)

Correspondence Address: LARSON AND LARSON, 11199 69TH STREET NORTH, LARGO, FL, 33773, US

(21) Appl. No.: 11/767,274

(22) Filed: Jun. 22, 2007

(51) Int. Cl. G06F 3/048

(52) U.S. Cl. 715/810; 715/700

(57) ABSTRACT

An application for providing point-of-contact family services includes providing a plurality of kiosks located at public points-of-contact, each kiosk having at least a computer system, a display, an input device and a network interface. At each of the kiosks, a main menu is presented with selections that include at least one selection for qualifying for assistance. In response to an applicant selecting the selection for qualifying for assistance, a qualifying for assistance data entry form is presented that includes data entry fields and a submit function. The applicant creates an application by inputting data into the qualifying for assistance data entry form, then, in response to the applicant selecting the submit function, the application is electronically mailed to an application server.

### FIELD OF THE INVENTION

This invention relates to the field of providing family services and more particularly to a system for providing family services at a location convenient to potential users of family services.

### BACKGROUND OF THE INVENTION

We all take for granted communications tools such as cell phones and the Internet. When we need to find information regarding an event, taxes, a new job, etc., we call someone on our phone (or cell phone) or we search for the information on the Internet. There are many families without such luxuries having not a phone or access to the Internet. Such families often need assistance and are eligible for assistance, but have no way to find out about available assistance because they lack a phone and a computer.

U.S. Pat. Application No. 2005/0137896 to Pentecost, et al., describes a recruiting system that allows job candidates to remotely interview or a provide audio/video resume for positions that involve, for example, singing and acting. If the candidate purchases audio/video recording equipment for use at home, the overall quality will likely be poor or, at the least, inconsistent. If the candidate goes to a professional studio, there will be substantial economic burden places on a person who is likely already out of work. Therefore, kiosks are provided at key locations (e.g., colleges) for the candidates to submit their resumes without the need for expensive audio/video equipment. The system of this application does not pre-qualify for assistance and services at a location of those who need assistance.

U.S. Pat. Application No. 2006/0263757 to Bender, describes a system for managing and messaging student information between parents and school administration/teachers. The system of this application does not pre-qualify for assistance and services at a location of those who need assistance.

U.S. Pat. No. 6,688,891 to Sanford, describes a system for a collaborative education process. It provides communications and information between students, parents and administrators but does not pre-qualify for assistance and services at a location of those who need assistance.

U.S. Pat. No. 6,766,319 to Might, describes a system for gathering and evaluating information. The system of this application does not pre-qualify for assistance and services at a location of those who need assistance.

What is needed is a system that will provide access to assistance at locations convenient to the targeted applicants.

### SUMMARY OF THE INVENTION

In one embodiment, a system for providing point-of-contact family services is disclosed including a computer located at a public point-of-contact within a kiosk, the computer has at least a display, an input device and a network interface and the computer provides a closed user interface configured to deliver family services at the public point-of-contact. The family services include at least information regarding the family services and a pre-qualification form for family assistance.

In another embodiment, a method of providing point-of-contact family services is disclosed including providing a plurality of kiosks located at public points-of-contact, each kiosk having at least a computer system, a display, an input device and a network interface. At each of the kiosks, a main menu is presented with selections that include at least one selection for qualifying for assistance. In response to an applicant selecting the selection for qualifying for assistance, a qualifying for assistance data entry form is presented that includes data entry fields and a submit function. The applicant creates an application by inputting data into the qualifying for assistance data entry form, then, in response to the applicant selecting the submit function, the application is electronically mailed to an application server.

In another embodiment, a computer program product for use with a plurality of kiosks located at public points-of-contact is disclosed. Each kiosk has a computer system, a display, an input device and a network interface for providing point-of-contact family services. The computer program product includes a computer usable medium having computer-readable software embodied in the medium. The software has a plurality of code for presenting a main menu with selections, the selections including at least a selection for qualifying for assistance. In response to an applicant selecting the selection for qualifying for assistance, a plurality of computer readable software presents a qualifying for assistance data entry form including data entry fields and a submit function. Software allows for the creation of an application by the applicant inputting data into the qualifying for assistance data entry form then, in response to the applicant selecting the submit function, additional code electronically mails the application to an application server.

In another embodiment, computer readable medium including computer programming instructions that cause a computer to perform a method for providing point-of-contact family services is disclosed. The method is used in conjunction with a plurality of kiosks located at public points-of-contacts, each kiosk has at least a computer system, a display, an input device and a network interface. The method includes presenting a main menu with selections that including at least a selection for qualifying for assistance. In response to an applicant selecting the selection for qualifying for assistance, a qualifying for assistance data entry form that includes data entry fields and a submit function is presented. The applicant creates an application by inputting data into the qualifying for assistance data entry form then in response to the applicant selecting the submit function, the application is emailed to an application server.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a high-level schematic view of a system of the present invention.

FIG. 2 illustrates a flow chart of the present invention.

FIG. 3 illustrates a flow chart of the qualification of the present invention.

FIG. 4 illustrates a flow chart of the flow of the qualification process of the present invention.

FIG. 5 illustrates a schematic network view of the application process of the present invention.

FIG. 6 illustrates a schematic view of a typical computer system of the present invention.

FIG. 6A illustrates a plan view of a typical Kiosk computer system of the present invention.

FIG. 7 illustrates a typical application screen of the present invention.

FIG. 8 illustrates a typical application screen of the present invention including a keyboard overlay.

FIG. 9 illustrates a typical location query screen of the present invention.

FIG. 10 illustrates a typical “about” screen of the present invention.

FIG. 11 illustrates a typical “contact” screen of the present invention.

FIG. 12 illustrates a typical “eligibility” screen of the present invention.

FIG. 13 illustrates a typical “job opportunities” screen of the present invention.

FIG. 14 illustrates a typical “job application” screen/form of the present invention.

FIG. 15 illustrates a typical “volunteer opportunities” screen of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

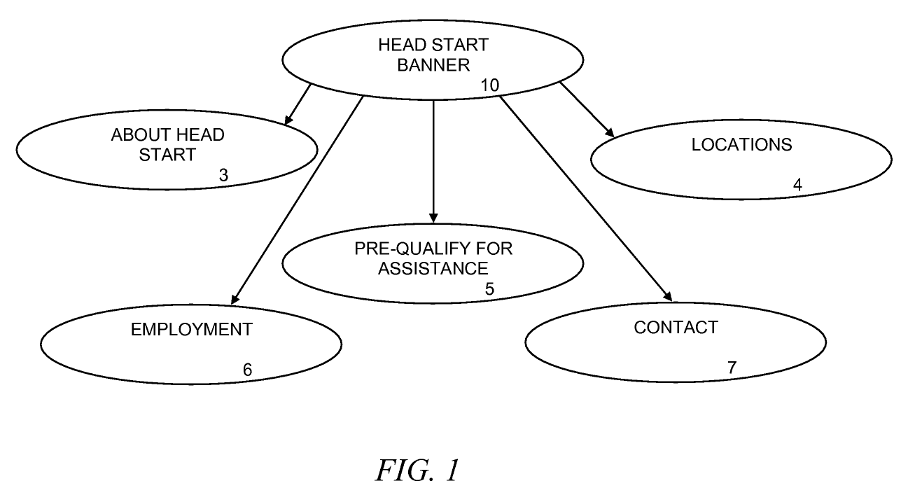

Referring to FIG. 1, a high-level schematic view of a system of the present invention will be described. The system of the present invention provides a terminal device such as a kiosk at a location where potential applicants often visit, hereby referred to as a public point of contact. There are many potential family services applicants without such luxuries as phones or access to the Internet. Such potential applicants often need assistance and are eligible for assistance, but have no way to find out about available assistance because they lack a phone and a computer. To improve on this situation, potential applicants a provided with terminal devices in public locations where they often frequent such as shopping stores, social service locations, health service locations, etc.

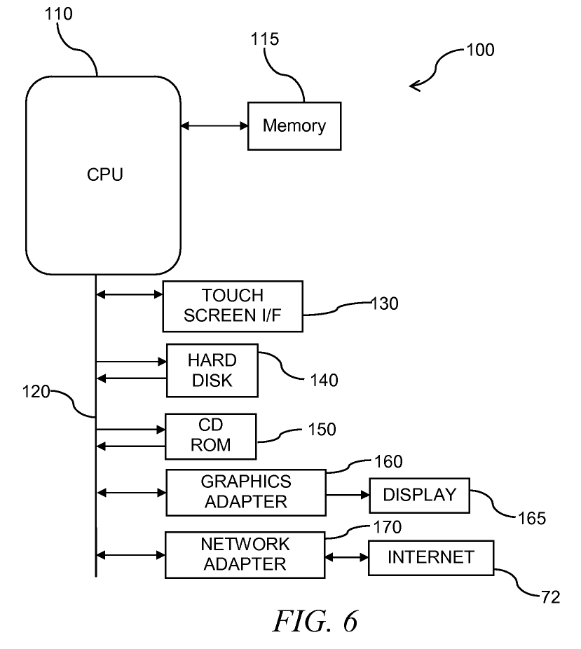

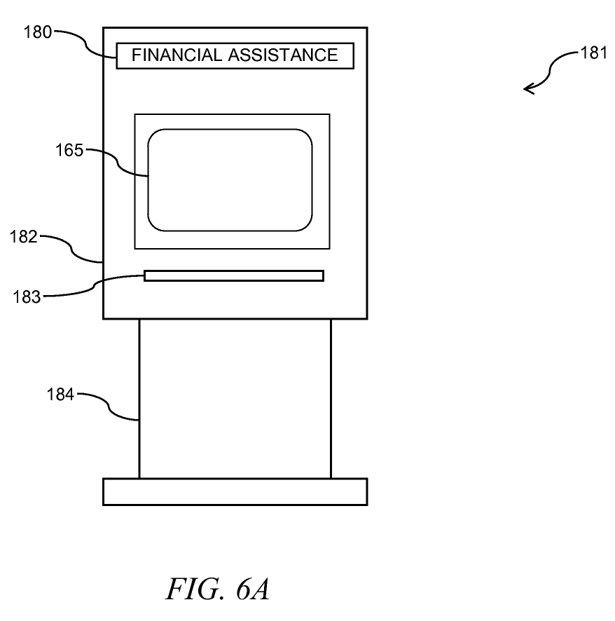

The terminal devices 100 (see FIGS. 6, 6A) are typical computer systems that are programmed to provide a closed user interface that provides a specific set of information and solicits applications from the applicant. The closed user interface provides, for example and not limited to, a banner page 10, an “about” page 3, a “locations” page 4, a “pre-qualify for assistance” page 5, an “employment” page 6 and a “contact” page 7. Other embodiments of the present invention provide additional pages such as “volunteer”, etc. Other embodiments of the present invention provide fewer pages such as without “locations”, etc. A closed user interface is one in which a fixed set of screens or pages are presented such that a user cannot reprogram the computer, access the operating system of the computer or obtain direct access to the files of the computer, networks, or other resources outside of the closed user interface.

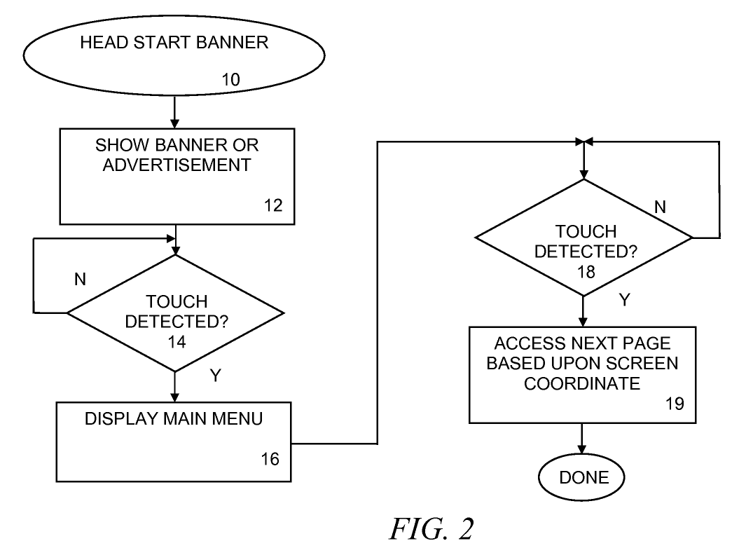

Referring to FIG. 2, a flow chart of the present invention will be described. In some embodiments, the user interface includes a banner or advertisement 12. The banner or advertisement 12 provides, for example, advertisement for the program to make potential applicants aware of its features (e.g., “Free Child Care”) or advertisements for other services or general advertisements. In some embodiments, a placard, either lighted or not, is positioned on the terminal device for advertisement purposes. In some embodiments, a display or video monitor is positioned on the terminal device for advertisement purposes. In embodiments using a touch screen, the user interface waits for a potential applicant to touch the touch screen 14, and then displays the main menu 16. The user interface then waits for the potential applicant to touch the screen 18 near one of the possible choices on the main menu and then proceeds to a next page based upon the screen coordinate of the touch 19, for example, to the “Qualify for Assistance” page.

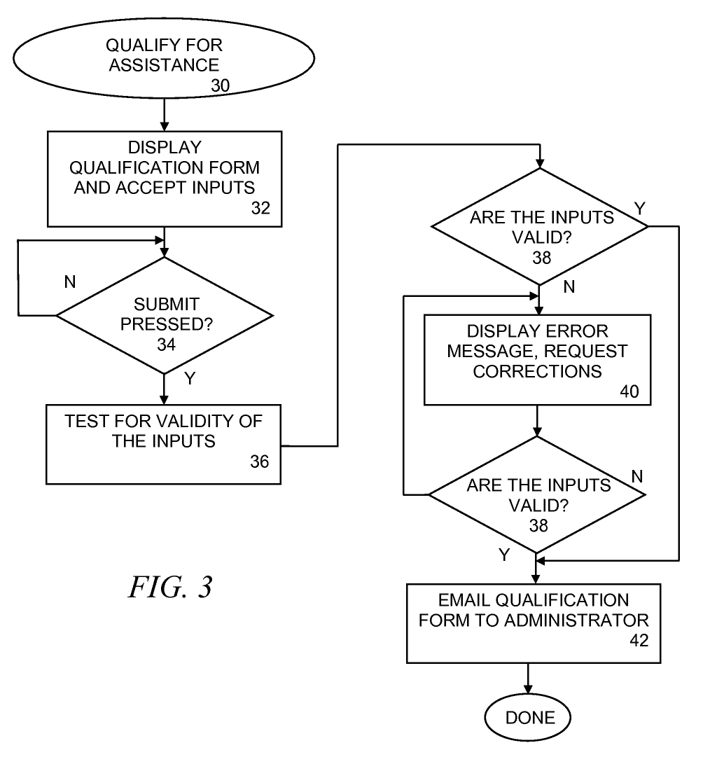

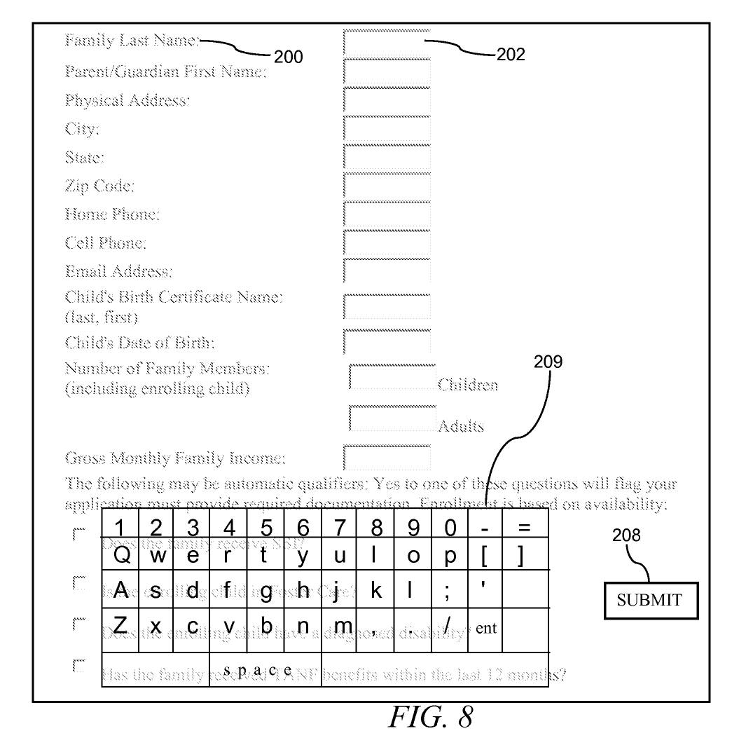

Referring to FIG. 3, a flow chart of the qualification step of the present invention will be described. In some embodiments, the user interface includes a “qualification for assistance” interface 30. The “qualification for assistance” interface 30 provides features and forms for entering data required to evaluate the applicant's need for assistance. After selecting the choice of “qualification for assistance” from the main menu, a qualification form is displayed and user inputs for each field are accepted 32 as known in the industry. For example, in one embodiment, the terminal device (e.g., kiosk) has a keyboard for entering information such as name, income, dependent information, etc. In another embodiment, the terminal device (e.g., kiosk) has a touch screen for entering information such as name, income, dependent information, etc. and a keyboard overlay is displayed (see FIG. 8) to facilitate such. Once the applicant has completed the qualification form (e.g., the application), the “submit” function is pressed or selected 34 and the qualification inputs are tested for validity 36 to assure completeness and meaningful data. For example, there must be an entry in family name, phone number must have 10 or 11 digits, family income must have numerical characters, etc. If the inputs are not valid 38, an error message is displayed 40. In some embodiments, the error message includes the reason for the error (e.g., the phone number is missing the area code). Once valid inputs are found 38 on the qualification form, the inputs are sent in an electronic mail message (emailed) to the administrator 42. It should be noted that in some embodiments, the format of such email to the administrator is identical to the format of an email to the administrator from a parallel web-based applications. In such, the administrator does not require a different procedure for those received from a fixed location terminal device (e.g., kiosk) or from a web-based computer such as a public computer in a library, etc.

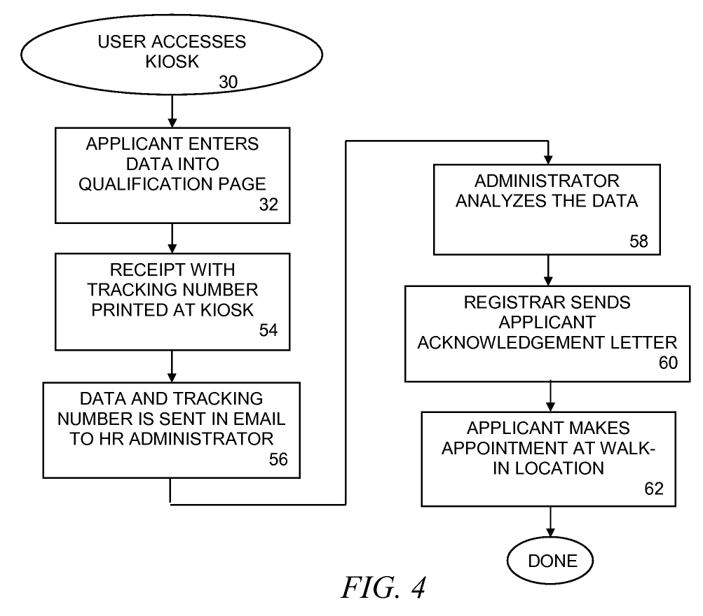

Referring to FIG. 4, a flow chart of the flow of the qualification process of the present invention will be described. As described previously, in some embodiments, the user interface includes a “qualification for assistance” interface 30. The “qualification for assistance” interface 30 provides features and forms for entering data required to evaluate the applicant's need for assistance. After selecting the choice of “qualification for assistance” from the main menu, a qualification form is displayed and user inputs for each field are accepted 32 (see FIG. 3) as known in the industry. In some embodiments, once the applicant has completed the qualification form, the “submit” function is pressed and the qualification inputs are valid 36 (see FIG. 3), a receipt is printed 54 at the terminal device (e.g., kiosk) for the applicant to take with them for future reference. For example, the receipt has the applicant name and a tracking number. Next, the data from the application and the tracking number is sent (e.g., by email) to the administrator 56 where the administrator analyzes the data 58 to determine eligibility, etc. Once complete, the administrator or registrar sends the applicant an acknowledgement letter 60 and, if applicable, the applicant makes an appointment at one of the walk-in locations 62.

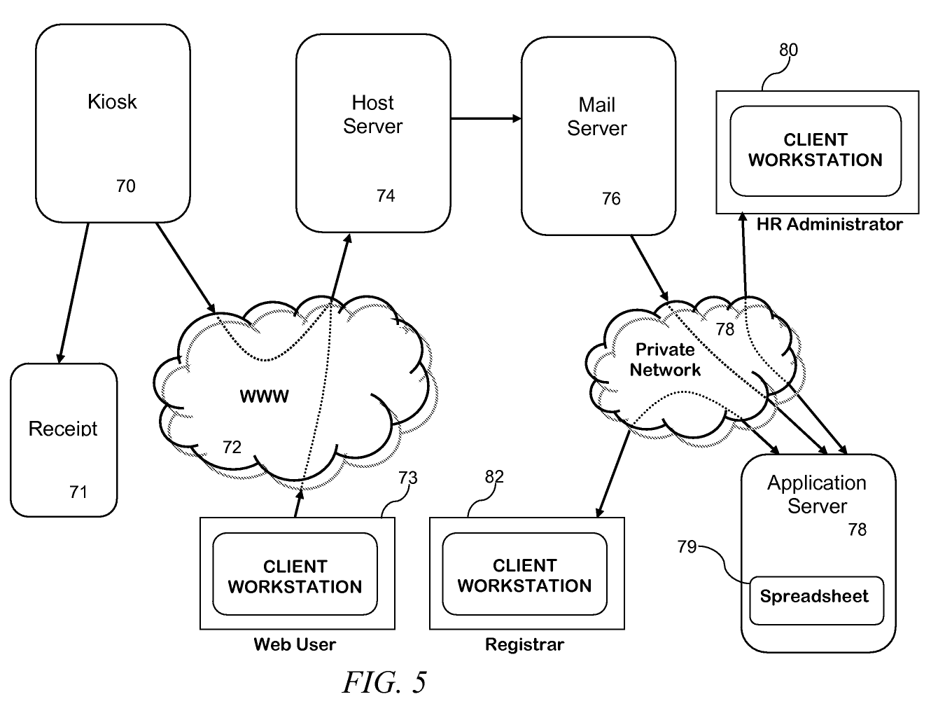

Referring to FIG. 5, a schematic network view of the application process of the present invention will be described. The applicant completes the application process at the terminal device or kiosk 70. In some embodiments, a receipt is printed 71 for them to take with them and refer to later. In some embodiments, information from the application is sent by email through the Internet (WWW) 72 to a host server 74 where it is forwarded to a mail server 76. In other embodiments, information from the application is sent by email through the Internet (WWW) 72 directly to a mail server 76 (path not shown). The mail server 76 then forwards the mail through a private network 78 (in some embodiments, through a public network) to an application server 78 which captures the data into internal data structures, databases, spreadsheets, etc. An administrator (HR administrator, etc.) 80 is notified of the new application through the network 78 and uses tools to determine if the applicant is eligible for services. Once the administrator has decided upon the case, a registrar 82 or other titled person is tasked with sending a letter to the applicant (paper mail or US mail). In some embodiments, data from the application is imported into a spreadsheet 79 for subsequent follow-up and statistical reporting. If approved, the letter requests that the applicant visit a walk-in facility to complete the enrollment process.

In some embodiments, the applicant applies through a web browser at a client workstation 73. The applicant completes the application process at a web based terminal device 73 such as a computer in a public library, etc. As in the previous embodiment, in some embodiments, information from the application is sent by email through the Internet (WWW) 72 to a host server 74 where it is forwarded to a mail server 76. In other embodiments, information from the application is sent by email through the Internet (WWW) 72 directly to a mail server 76 (path not shown). The mail server 76 then forwards the mail through a private network 78 (in some embodiments, through a public network) to an application server 78 which captures the data into internal data structures, databases, spreadsheets, etc. An administrator (HR administrator, etc.) 80 is notified of the new application through the network 78 and uses tools to determine if the applicant is eligible for services. Once the administrator has decided upon the case, a registrar 82 or other titled person is tasked with sending a letter to the applicant (paper mail or US mail). If approved, the letter requests that the applicant visit a walk-in facility to complete the enrollment process.

Referring to FIG. 6, a schematic view of a typical terminal device computer system 100 of the present invention will be described. This exemplary configuration is well known in the prior art. Although shown in a much simplified configuration having a single processor 110, many different computer architectures are known that accomplish similar results in a similar fashion and the present invention is not limited in any way to any particular computer system. The present invention works well utilizing a single processor system as shown; a multiple processor system where multiple processors share resources such as memory and storage; or a multiple server system where several independent servers operate in parallel or any combination. In this, a processor 110 is provided to execute stored programs that are generally stored for execution within a memory 115. The processor 110 can be any processor or a group of processors, for example an Intel Pentium-4® CPU or the like. The memory 115 is connected to the processor and can be any memory suitable for connection with the selected processor 110, such as SRAM, DRAM, SDRAM, RDRAM, DDR, DDR-2, etc. Also connected to the processor 110 is a system bus 120 for connecting peripheral subsystems such as a touch screen 130, a hard disk 140, a CDROM 150, graphics adapter 160 and network adapter 170. The graphics adapter 160 receives commands and display information from the system bus 120 and generates a display image that is displayed on the terminal's display 165. The network adapter 170 receives commands and data from the system bus 120 and communicates with the World Wide Web or Internet 72, through a modem or other communication device (not shown).

In some embodiment, there is a the hard disk 140 that is used to store programs, executable code and data persistently, while the CDROM 150 may be used to load said programs, executable code and data from removable media onto the hard disk 140. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. In some embodiments, other devices are connected to the system through the system bus 120 or with other input-output connections. Examples of these devices include printers; mice; graphics tablets; joysticks; and communications adapters such as modems and Ethernet adapters.

Referring to FIG. 6A, a plan view of a typical Kiosk computer system 181 of the present invention will be described. In some embodiments, the terminal device used to capture applicant information is a kiosk 181 that has a cabinet 182 for housing the computer system 100, display 165 and other associated electronics (not shown). In some embodiments, a receipt printer 183 is present in the kiosk 181. The kiosk is supported on a pedestal 184 or other support means. In some embodiments advertising or information is displayed on a placard or auxiliary display device 180. Central to the kiosk is a video display 165 for displaying information, menus and forms and for capturing application data from prospective applicants. In some embodiments, the video display 165 is overlaid with a touch screen allowing the prospective applicants to enter application information, etc. In some embodiments, a keyboard (not shown) is provided allowing the prospective applicants to enter application information, etc.

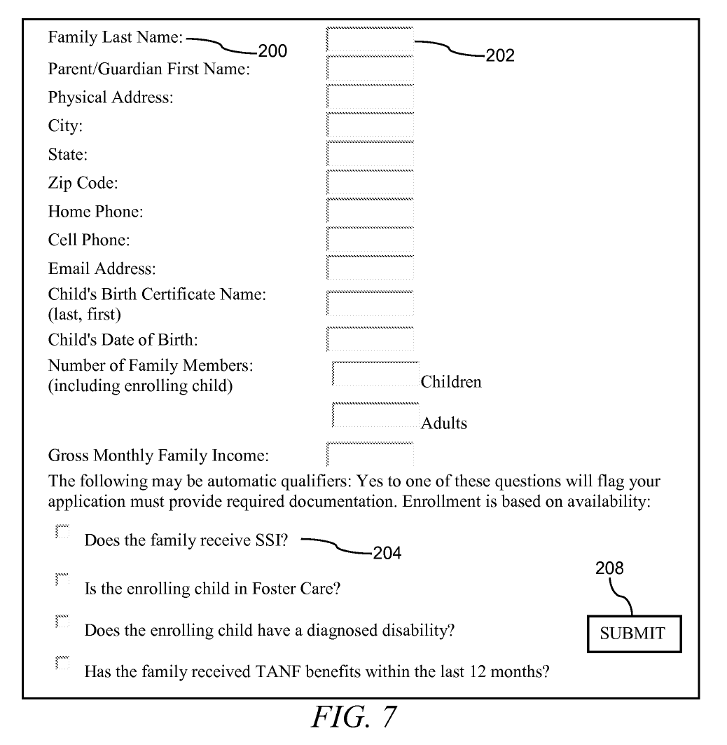

Referring to FIG. 7, a typical application screen of the present invention will be described. This screen is displayed when the applicant selects “pre-qualify for assistance” 5 on the main menu 10. On this form, the applicant enters information regarding themselves and the dependant child for which they seek assistance. Field names such as “Family Last Name” 200 are displayed next to data entry boxes 202 where the applicant enters the appropriate information. Some inputs such as “Does the family receive SSI” 204 require only a check-box to be selected. Once all information is entered, the applicant selects the submit button 208 and the information is sent to the administrator as previously described.

Referring to FIG. 8, a typical application screen of the present invention including a keyboard overlay will be described. This screen is displayed when the applicant selects “pre-qualify for assistance” 5 on the main menu 10. On this form, the applicant enters information regarding themselves and the dependant child for which they seek assistance using an overlay keyboard 209. The overlay keyboard lets the applicant enter information by touching the touch screen of the kiosk in the boxes corresponding to alpha-numeric characters. Field names such as “Family Last Name” 200 are displayed next to data entry boxes 202 where the applicant enters the appropriate information. Some inputs such as “Does the family receive SSI” 204 require only a check-box to be selected. Once all information is entered, the applicant selects the submit button 208 and the information is sent to the administrator as previously described.

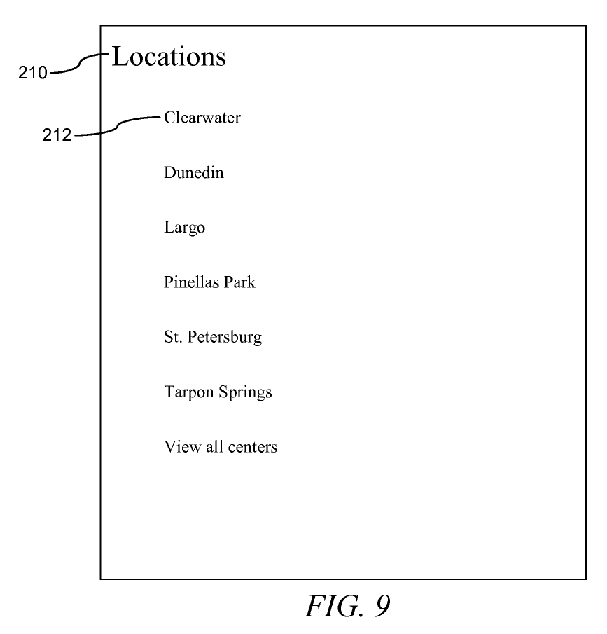

Referring to FIG. 9, a typical location query 210 screen of the present invention will be described. This screen presents locations of the various walk-in locations where the applicant needs to go to complete the enrollment process. For example, one location is in Clearwater 212. Selecting the desired location will provide the applicant with detailed location information such as addresses, phone numbers and maps.

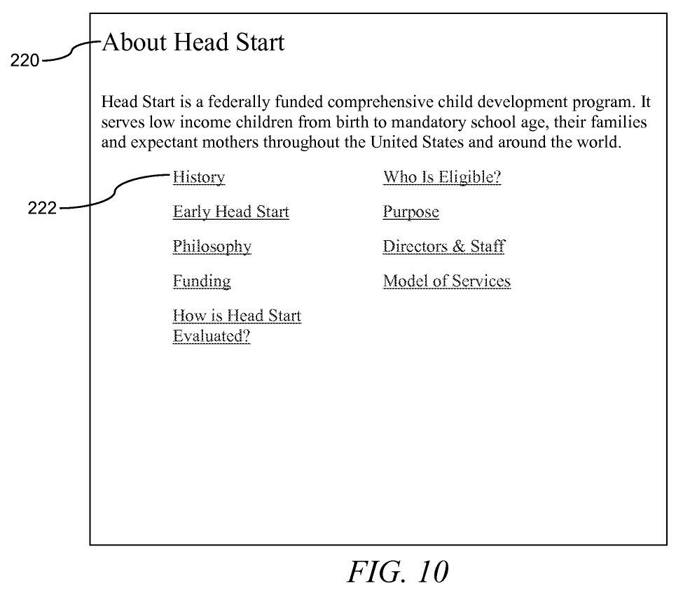

Referring to FIG. 10, a typical “about” screen of the present invention will be described. This screen presents information about the program and employees. For example, information regarding the history of the program 222 is available 220 through this screen. Selecting the desired location will provide the applicant with detailed location information such as addresses, phone numbers and maps.

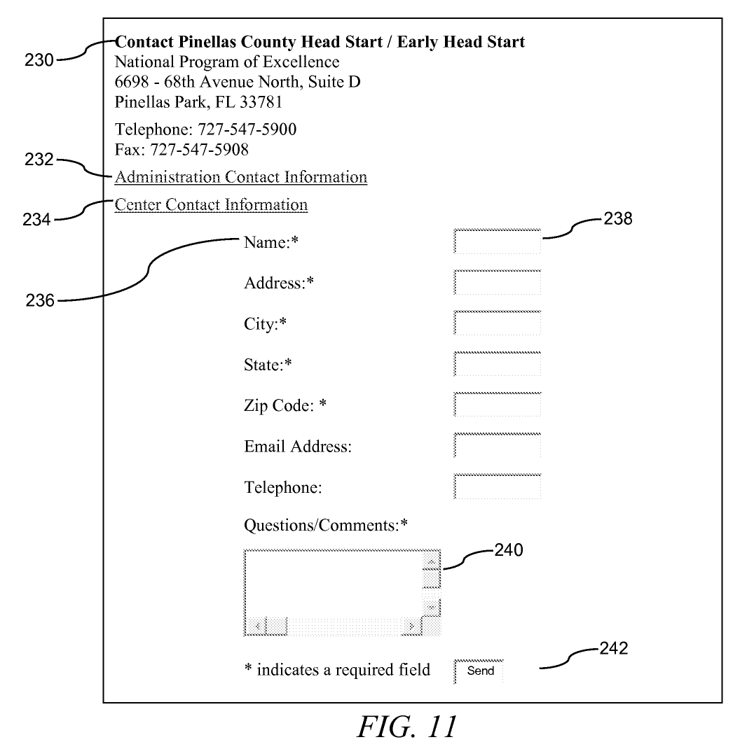

Referring to FIG. 11, a typical “contact” screen of the present invention will be described. This screen presents contact information 230, specific contact information links 232/234 and permits the prospective applicant to submit a question or comment by filling out a question/comment form that is similar to the application form described previously with field names (e.g. “Name:” 236) with adjacent text entry fields 238 that are populated with data through the keyboard or touch screen as described previously. There is a text entry field 240 where the prospective applicant inputs their question or comment. Once finished, the prospective applicant selects the send button 242 and the question/comment is sent through similar paths as the application to the application server 78.

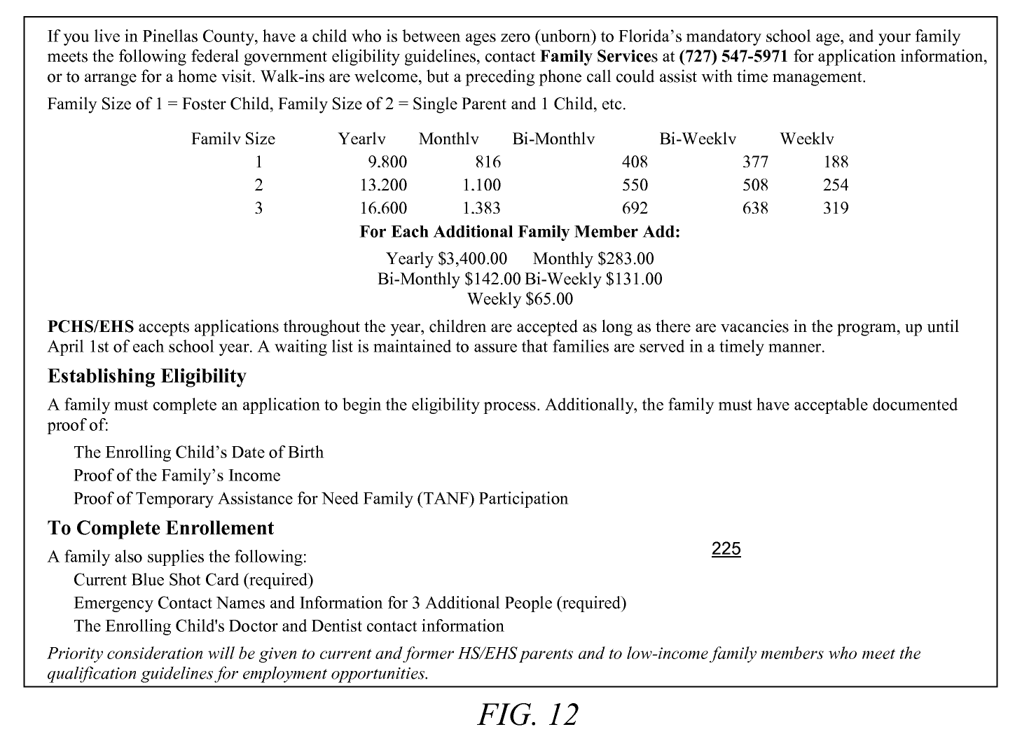

Referring to FIG. 12, a typical “eligibility” screen of the present invention will be described. This screen is displayed when the prospective applicant selects the “Who is Eligible” link from the “About” screen 220. The “eligibility” screen 225 has information regarding the income levels and family attributes that must be met in order to obtain assistance.

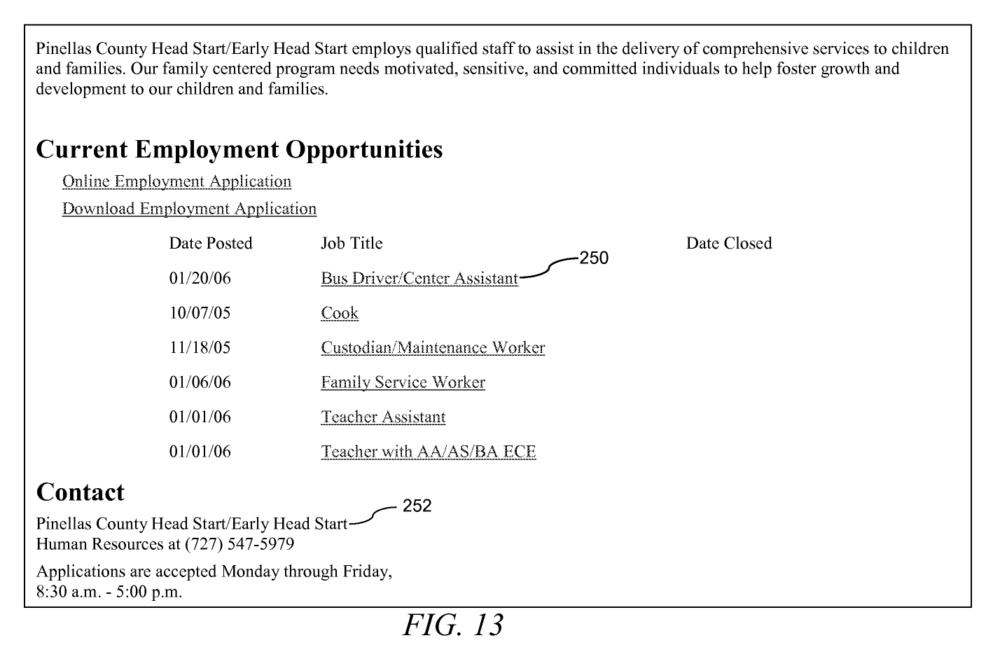

Referring to FIG. 13, a typical “job opportunities” screen of the present invention will be described. This screen presents a list of links to current job opportunities within the organization such as “Bus Driver/Center Assistant” 250. Clicking on one of these links will provide detailed information regarding the job opportunity such as skills required, hours and pay rates. Contact information 252 is provided for a potential job seeker to find out more information about the opportunity.

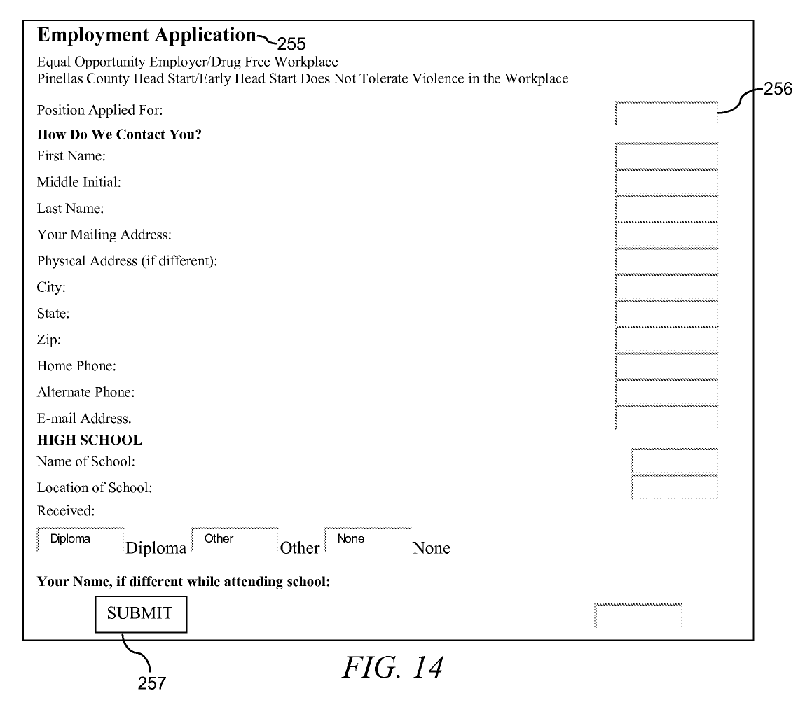

Referring to FIG. 14, a typical “job application” screen/form 255 of the present invention will be described. The screen shown is a sampling of the information gathered regarding the applicant in text fields 256 in which applicant information is entered as previously described using a keyboard or touch screen. Other information is requested upon the same screen/form 255 or auxiliary forms (not shown) including college information, employment history and citizenship. Once all desired information has been entered, the submit button 257 is selected and the application is delivered to the application server 78 by similar means as the assistance application.

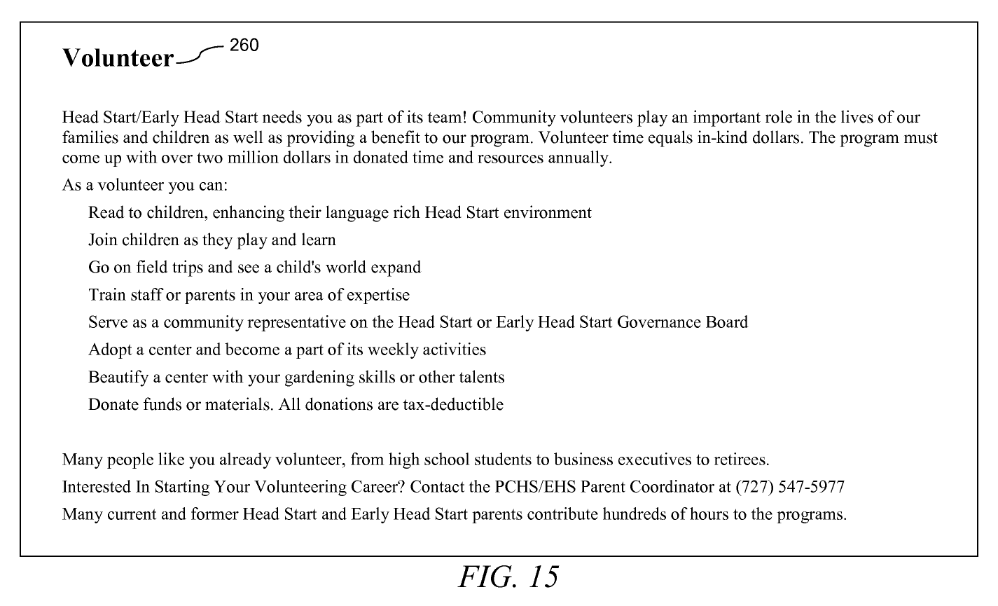

Referring to FIG. 15, a typical “volunteer opportunities” screen 260 of the present invention will be described. The volunteer information screen is an informational screen describing various activities in which the applicant or other interested party are able to perform as volunteers. Contact information is provided to those who are interested.

Although all screens are shown in English, the present invention works equally well in other languages such as Spanish. In some embodiments, there is a selection to select another language, such as Spanish, causing the software to redraw all screens in that language and allowing the applicant to enter data into screens such as the assistance application screen in that language. In such cases, the validation software that assures valid inputs (see description related to the “submit” function of FIG. 3) is adjuster for the different language, as needed. For example, if Spanish is selected, the software need allow special characters such as “ñ”.

Equivalent elements can be substituted for the ones set forth above such that they perform in substantially the same manner in substantially the same way for achieving substantially the same result. Although the terminal device is described in the preferred embodiment as a “kiosk,” the present invention is not limited to the described kiosk. The present invention works equally well with other forms of kiosks having touch screens, keyboards, mice, joysticks, cameras and/or microphones. The present invention also works equally well with stand-alone, dedicated computer systems installed in public places similar to library computers but with fixed user interfaces so as not to confuse the prospective applicant.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for providing point-of-contact family services, the system comprising:
a computer located at a public point-of-contact within a kiosk, the computer having at least a display, an input device and a network interface; and
wherein the computer is operative to provide a closed user interface configured to deliver family services at the public point-of-contact, the family services include at least information regarding the family services and a pre-qualification form for family assistance.

2. The system for providing point-of-contact family services of claim 1, wherein the input device is a touch screen interface operatively coupled to the computer.

3. The system for providing point-of-contact family services of claim 1, wherein the input device is a keyboard operatively coupled to the computer.

4. The system for providing point-of-contact family services of claim 1, wherein the family service further include job opportunities and volunteer opportunities.

5. The system for providing point-of-contact family services of claim 1, further comprising an application server, whereby information from the pre-qualification form for family assistance is sent through the network interface and through a network from the kiosk to an application server.

6. The system for providing point-of-contact family services of claim 5, wherein the information from the pre-qualification form for family assistance is sent in an electronic mail message.

7. The system for providing point-of-contact family services of claim 6, wherein the information from the pre-qualification form for family assistance includes at least a family name, an address, a child's name, a child's birth date and a gross family income.

8. A method of providing point-of-contact family services, the method comprising:
providing a plurality of kiosks located at public points-of-contact, each kiosk comprising at least a computer system, a display, an input device and a network interface;
at each of the kiosks:
presenting a main menu with selections, the selections including at least a selection for qualifying for assistance;
in response to an applicant selecting the selection for qualifying for assistance:
presenting a qualifying for assistance data entry form including data entry fields and a submit function;
creating an application by the applicant inputting data into the qualifying for assistance data entry form; and
in response to the applicant selecting the submit function, emailing the application to an application server.

9. The method of claim 8, wherein the input device is a touch screen interface operatively coupled to the computer system.

10. The method of claim 8, wherein the input device is a keyboard operatively coupled to the computer system.

11. The method of claim 8, further comprising the following steps after the step of emailing:
receiving the application at the application server;
forwarding the application to an administrative person; and
sending a letter by mail to the applicant indicating a disposition of the application.

12. The method of claim 8, wherein the kiosks further include a printer and in response to the applicant selecting the submit function, printing a receipt.

13. The method of claim 12, wherein both the receipt and the application include a tracking number.

14. The method of claim 8, wherein data from the application is imported into a spreadsheet at the application server.

15. A computer program product for use with a plurality of kiosks located at public points-of-contact, each kiosk comprising at least a computer system, a display, an input device and a network interface for providing point-of-contact family services, the computer program product comprising:
a computer usable medium having computer-readable code means embodied in the medium, the computer-readable code means comprising:
a plurality of computer readable code means for presenting a main menu with selections, the selections including at least a selection for qualifying for assistance;
in response to an applicant selecting the selection for qualifying for assistance:
a plurality of computer readable code means for presenting a qualifying for assistance data entry form including data entry fields and a submit function;
a plurality of computer readable code means for creating an application by the applicant inputting data into the qualifying for assistance data entry form; and
in response to the applicant selecting the submit function, a plurality of computer readable code means for emailing the application to an application server.

16. The computer program product for use with a plurality of kiosks located at public points-of-contact of claim 15, wherein the input device is a touch screen interface operatively coupled to the computer system.

17. The computer program product for use with a plurality of kiosks located at public points-of-contact of claim 15, wherein the input device is a keyboard operatively coupled to the computer system.

18. The computer program product for use with a plurality of kiosks located at public points-of-contact of claim 15, further comprising the following steps after the step of emailing:
a plurality of computer readable code means for receiving the application at the application server;
a plurality of computer readable code means for forwarding the application to an administrative person; and
a plurality of computer readable code means for sending a letter by mail to the applicant indicating a disposition of the application.

19. The computer program product for use with a plurality of kiosks located at public points-of-contact of claim 15, wherein the kiosks further include a printer and in response to the applicant selecting the submit function, printing a receipt.

20. The computer program product for use with a plurality of kiosks located at public points-of-contact of claim 19, wherein both the receipt and the application include a tracking number.

21. The computer program product for use with a plurality of kiosks located at public points-of-contact of claim 15, wherein data from the application is imported into a spreadsheet at the application server.

22. A computer readable medium including computer programming instructions that cause a computer to perform a method for providing point-of-contact family services, the method used with a plurality of kiosks located at public points-of-contact, each kiosk comprising at least a computer system, a display, an input device and a network interface, the method comprising the steps of:
presenting a main menu with selections, the selections including at least a selection for qualifying for assistance;
in response to an applicant selecting the selection for qualifying for assistance:
presenting a qualifying for assistance data entry form including data entry fields and a submit function;
creating an application by the applicant inputting data into the qualifying for assistance data entry form; and
in response to the applicant selecting the submit function, emailing the application to an application server.

23. The computer program product for use with a plurality of kiosks located at public points-of-contact of claim 22, wherein the input device is a touch screen interface operatively coupled to the computer system.

24. The computer program product for use with a plurality of kiosks located at public points-of-contact of claim 22, wherein the input device is a keyboard operatively coupled to the computer system.

25. The computer program product for use with a plurality of kiosks located at public points-of-contact of claim 22, further comprising the following steps after the step of emailing:
a plurality of computer readable code means for receiving the application at the application server;
a plurality of computer readable code means for forwarding the application to an administrative person; and
a plurality of computer readable code means for sending a letter by mail to the applicant indicating a disposition of the application.

26. The computer program product for use with a plurality of kiosks located at public points-of-contact of claim 22, wherein the kiosks further include a printer and in response to the applicant selecting the submit function, printing a receipt.

27. The computer program product for use with a plurality of kiosks located at public points-of-contact of claim 26, wherein both the receipt and the application includes a tracking number.

28. The computer program product for use with a plurality of kiosks located at public points-of-contact of claim 22, wherein data from the application is imported into a spreadsheet at the application server.
